(19) United States
(12) Patent Application Publication
(10) Pub. No.: US 2013/0273922 A1
(43) Pub. Date: Oct. 17, 2013

(54) METHODS AND DEVICES FOR CELL RE-CONFIGURATION

(71) Applicants: Jan Christoffersson, Lulea (SE); Min Wang, Lulea (SE); Andreas Höglund, Stockholm (SE)

(72) Inventors: Jan Christoffersson, Lulea (SE); Min Wang, Lulea (SE); Andreas Höglund, Stockholm (SE)

(21) Appl. No.: 13/976,390

(22) PCT Filed: Dec. 27, 2010
(86) PCT No.: PCT/SE2010/051484

§ 371 Date: Jun. 26, 2013

(51) Int. Cl. H04W 16/24

(52) U.S. Cl. CPC H04W 16/24
USPC 455/446

(57) ABSTRACT

Reconfiguration from a multi cell configuration to an omni-cell configuration comprises blocking the cells cells of the multi cell configuration for new users whereby a user equipment is prevented from accessing any of the cells in the multi cell configuration, updating handover triggering settings with settings set to empty the cells (This can for example comprise of successively lowering the power in a pilot channel such as the common pilot channel (CPICH) in the cell(s) to be emptied or by a direct HO command from a node such as the RNC to the user equipment(s) in the cell(s)), and beginning reconfiguration from the multi cell configuration to the omni-cell configuration when all cells in the multicell configuration are empty. Other methods and devices for reconfiguring between multicell configurations and omnicell configurations and vice versa are also disclosed.

### TECHNICAL FIELD

The present invention relates to methods and devices for cell reconfiguration. In particular the invention relates to methods and devices for reconfiguring a cell from a multi cell configuration to an omni-cell configuration or vice versa.

### BACKGROUND

Up until recently optimizing wireless by communication maximizing peak rates and the number of supported user equipments (also termed users herein), i.e. focusing on high load situations, has been prioritized. More recently there has been a growing interest in conserving energy in the base station, both from an environmental and cost saving perspective. Since most cellular radio networks operate at low load most of the time, even a small energy saving at low load will have a large impact over time. Because of this, there is an interest to improve the energy, especially in low load situations.

The methods for saving energy are typically about turning off power consuming features when they are not used or needed. Examples of this is turning off carriers in a multi carrier scenario or turning off one Multiple Input Multiple Output (MIMO) antenna and its corresponding Power Amplifier (PA) in case no MIMO users are present in a MIMO enabled cell. Other methods are discontinuous Common Pilot Channel (CPICH) and control signaling transmissions.

One particular method for energy saving is by reconfiguring a 3-cell base station site into a 1-cell omni-directional site. In a low load scenario, the Omni-cell site can handle the traffic and considerable energy savings are obtained since only one PA is needed for the entire site compared to three PAs in the 3-cell site case. An illustration of the reconfiguration is seen in FIG. 1.

When reconfiguration between 3-cell sites and Omni-cell sites, the 3-sector antenna can be used to give an omni directional antenna as described in US Patent Application US 2008/0287163 A1, or by equipping the site with both 3-sector antennas and an Omni antenna.

Such a reconfiguration will require handover of UEs from one cell to another. The Handover (HO) procedure is defined as a group of consecutive HO Radio Resource Control (RRC) signaling messages. The procedure is started when the user transmits the measurement report message, and ends when the user accesses the target cell successfully via the RACH channel and transmits the confirm message. HO is triggered based on downlink radio channel quality measurements. The measurements are normally periodically reported from a User Equipment (UE) to the Serving Radio Network Controller (SRNC). The HO is triggered if the radio quality of the serving cell is a number of dB (it is so called HO Hysteresis Trigger) lower than that of the target cell for a defined period (so called HO Time-to-Trigger). The UE may report a best cell list in particular a list including all the neighboring cells, which have higher radio channel quality than the serving cell.

When reconfiguring a cell which contains active users, there will typically be service interruptions such as Radio Link (RL) failure or even dropped sessions or users. Hence, applying cell reconfiguration to enhance energy consumption may lead to unwanted quality degradation for the users. This is undesired and a need for improved methods and devices for reconfigurations of cells hence exists.

### SUMMARY

It is an object of the present invention to provide an improved methods and devices to address the problems as outlined above.

This object and others are obtained by the methods and devices as set out in the appended claims.

As has been realized by the inventors, if the reconfiguration is to be carried out without degrading the Quality of Service (QoS), the cells that are subject to reconfiguration should be empty. This further implies that it is required to either wait until the cells are empty, which will not be optimal from an energy efficiency perspective since benefits are obtainable already at low loads (i.e. few users or low bitrate in the cell) or actively empty the cell by handing users over to other cells that are not subject of reconfiguration. One method to empty a cell is to gradually decrease the CPICH power of the cell. This will decrease the coverage of the cell and eventually trigger the user to hand over to another cell, in particular a neighboring cell. Drawbacks of this method is that decreasing the CPICH power should be done relatively slow and that there is no guarantee that after shrinking the cell, there is a sufficiently good other cell that the user(s) can hand over to. As a result, there is a risk of dropping users if this method is applied.

Hence, in order to empty a cell, a HO algorithm for improved energy efficiency is needed which is reasonably fast and which do not risk the user performance, i.e. cause RL failure or dropped users.

Furthermore, the cells which are subject to reconfiguration also need to be blocked during the reconfiguration, in order to guarantee that the users, who are planning to access this cell, will not be interrupted by the reconfiguration. The normal way to block a cell is to reject the access request for new users, or HO users, via the Random Access Channel (RACH). When the users get the reject indication, they will instead try to access other cells. This implies that these users will experience a longer delay until being served, which is not desired.

In accordance with embodiments described herein methods and sets of steps performed to define when and how to do hand over to other cells, in particular neighboring cells are provided. The methods and criteria can be set to differ depending if reconfiguration is done from a multi cell , e.g. 3-cell site, to an Omni-cell site or vice versa.

In accordance with one embodiment if a reconfiguration is performed from a multi cell configuration, e.g. 3-cell configuration, to omni situation, a site (or cell) is identified as reconfiguration candidate (to Omni). Different steps may be used for this, e.g. no of users in the site or site throughput or other limiting factor for an Omni-cell site.

In accordance with one embodiment a reconfiguration from a multi cell configuration to a omni-cell configuration comprises blocking cells of the multi cell configuration for new users whereby a user equipment is prevented from access any of the cells in the multi cell configuration, updating handover triggering settings with new settings set to empty the cells at an increased handover rate or speed. (This can for example comprise of successively lowering the power in a pilot channel such as the common pilot channel (CPICH) in the cell(s) to be emptied or by a direct HO command from a node such as the RNC to the user equipment(s) in the cell(s)), and beginning reconfiguration from the multi cell configuration to the omni-cell configuration when all cells in the multicell configuration are empty.

In accordance with one embodiment the reconfiguration is initiated when the number of served user equipments or the cell throughput provided is below a threshold.

In accordance with one embodiment cells are blocked by transmitting a broadcast message informing user equipments that a cell/cell(s) cannot be accessed during a period. Hereby, during reconfiguration a UE in an area affected by reconfiguration can be informed that a cell cannot be accessed. This in turn can result in a reduced delay because a UE will not need to perform an access attempt to discover that a cell is blocked.

In accordance with one embodiment if no other cell has a received signal code power above a threshold, one or more of the following steps are performed:
retry after a time period,
update handover triggering settings with settings set to empty the cells at a higher increased handover rate or speed settings,
wait until the user equipment is finished

In accordance with embodiments described, the cells in the site are blocked for new users. UEs may not access any of the cells unless they are at risk of not complying with QoS in the cell where they currently reside. If a new user is admitted the reconfiguration is aborted. Node B/RNC updates the HO triggering settings with new settings set to empty the cells at an increased handover rate or speed which will then trigger HO to the best (not blocked) cell only if the Received Signal Code Power (RSCP) from this cell is above a threshold that guarantees QoS during reconfiguration to Omni. If no other cells have RSCP above that threshold no HO will take place and the reconfiguration is aborted. Once the cells in the site are empty, reconfiguration is started.

To do the reverse reconfiguration, i.e. from Omni-cell configuration to a multi-cell configuration, e.g. a 3-cell site, the following steps can be performed.

Once, a site (or cell) is identified as reconfiguration candidate, e.g. when an Omni-cell can not support the traffic in the Omni-cell, reconfiguration to a multi cell configuration is commenced. This means that the cell is blocked for new users and emptied and finally reconfigured.

If the site is an Omni-cell, rules for reconfiguration to 3-cell also need to consider HO possibilities to guarantee QoS when reconfiguring to 3-cell. This means that if new users wish to do HO to the Omni-cell and there is no other cell which has received RSCP above some threshold then the site needs to be reconfigured to 3-cell before admitting user. Further, the received RSCP from other cells must be monitored (continuously) for all users in the Omni-cell. If it drops below the threshold for some user, reconfiguration to 3-cell must start. These criteria make it possible to reconfigure the Omni-cell site to a 3-cell site with no or little impact on the QoS.

In accordance with one embodiment a method in a node of a cellular radio system for reconfiguration from a multi cell configuration to an omni-cell configuration is provided. In accordance with such an exemplary method first cells of the multi cell configuration are blocked for new users by preventing a user equipment from access any of the cells in the multi cell configuration. The handover triggering settings are updated for user equipments in the cells of the multi cell configuration with new settings set to empty the cells at an increased handover rate or speed thereby triggering a handover, and reconfiguration from the multi cell configuration to the omni-cell configuration when all cells in the multicell configuration are empty. The settings newfor triggering a handover can for example comprise of successively lowering the power in a pilot channel such as the common pilot channel (CPICH) in the cell(s) to be emptied or by a direct HO command from a node such as the RNC to the user equipment(s) in the cell(s). Also, when the reconfiguration is completed, the old handover triggering settings, applied before the reconfiguration commenced, can be reinstated and used again.

In accordance with one embodiment the reconfiguration is aborted if a user equipment determined to not comply with a Quality of Service unless given access to a cell in the multi cell configuration.

In accordance with one embodiment the handover triggering settings are updated in a radio base station, Node B, or a Radio Network Controller.

In accordance with one embodiment the reconfiguration is aborted if no other cell for a user has a received signal code power above a threshold value.

In accordance with one embodiment a method in a node of a cellular radio system for reconfiguration from an omni-cell configuration to a multi cell configuration is provided. In accordance with such an exemplary method first the omni cell configuration is blocked for new users by preventing a user equipment from access to the omni cell. Then handover triggering settings are updated with new settings set to empty the cells at an increased handover rate or speed triggering a handover setting for user equipments in the omni cell. Reconfiguration from the omni-cell configuration to the multi cell configuration is begun when the omnicell is empty. The settings for settings for triggering a handover can for example comprise of successively lowering the power in a pilot channel such as the common pilot channel (CPICH) in the cell(s) to be emptied or by a direct HO command from a node such as the RNC to the user equipment(s) in the cell(s). Also, when the reconfiguration is completed, the old handover triggering settings, applied before the reconfiguration commenced, can be reinstated and used again.

In accordance with one embodiment the reconfiguration is aborted if it is determined that there is no alternative cell for a user equipment in the Omni-cell.

In accordance with one embodiment the determination that there is no alternative cell for a user equipment in the Omni-cell is based on a set of predefined criteria.

In accordance with one embodiment other cells are monitored to ensure that there is an alternative cell for users in the Omni-cell.

In accordance with one embodiment the reconfiguration is initiated when the number of served user equipments or the cell throughput provided is above a threshold.

The invention also extends to and a radio base stations Node B and central network nodes arranged to perform the methods as described herein. The radio base station Node B/central network node can be provided with a controller/controller circuitry for performing the above methods. The controller(s) can be implemented using suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor or may include, without limitation, digital signal processor (DSP) hardware, ASIC hardware, read only memory (ROM), random access memory (RAM), and/or other storage media.

### BRIEF DESCRIPTION OF THE DRAWINGS

The present invention will now be described in more detail by way of non-limiting examples and with reference to the accompanying drawing, in which:

FIG. 1 is an illustration of a reconfiguration

FIG. 2 is a view of a cellular radio system,

FIG. 3 is a flowchart illustrating some steps performed when reconfigurating a cell from a multi cell configuration to an omni-cell configuration,

FIG. 4 is an illustration of an exemplary HO procedure of users during a reconfiguration from a multi site configuration to an omni site configuration, and

FIG. 5 is a flowchart illustrating some of the above steps performed when reconfigurating a cell from an omni-cell configuration to a multi cell configuration.

### DETAILED DESCRIPTION

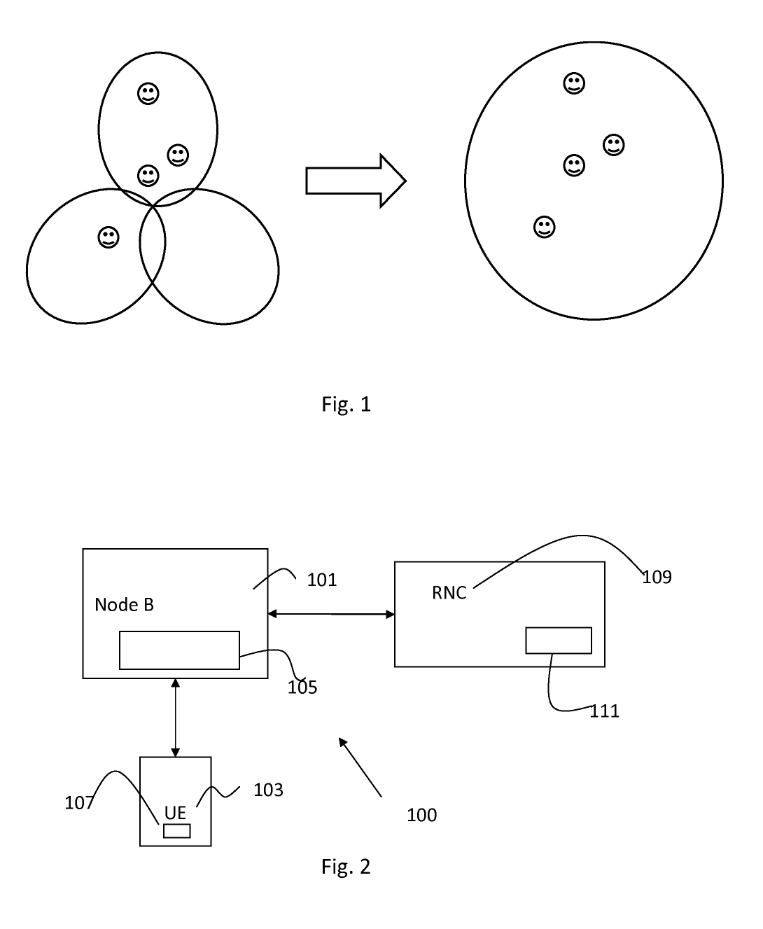

In FIG. 2 a general view of a cellular radio system 100 is depicted. The system 100 depicted in FIG. 1 is a UMTS Terrestrial Radio Access Network (UTRAN) system. However it is also envisaged that the system can be an evolved UTRAN (E-UTRAN) system or another similar systems. The system 100 comprises a number of base stations 101, where only one is shown for reasons of simplicity. The base station 101 can be connected to user equipments, represented by the UE 103 in the figure, located in the area served by the base station 101. The base station and the user equipment further comprise controllers/controller circuitry 105 and 107 for providing functionality associated with the respective entities. The controllers 105 and 107 can for example comprise suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor may include, without limitation, digital signal processor (DSP) hardware, ASIC hardware, read only memory (ROM), random access memory (RAM), and/or other storage media. Further a central Node 109 for controlling a number of radio base stations is typically provided. In the case of an UTRAN system the central node can be a radio network controller (RNC) 109. The central node 109 also comprise controllers/controller circuitry 111 for providing functionality associated with the central node.

Below some detailed examples are given both when a reconfiguration from a multi cell to an omni cell and from an omni cell to a multicell. First an example of reconfiguration from a multi cell site to an omnicell site is given. The example assumes that the multicell site is a 3-cell site but other sizes are also envisaged.

First a site is identified as reconfiguration candidate, i.e. the site is identified to be reconfigured to an omni site. This can be done based on a base criterion. The base criterion can for example be:

Base Criterion: The number of users served in 3-cell site or the site (cell) throughput drops under a threshold. .

When the number of served users or the cell throughput provided drops under the threshold, a reconfiguration of the 3-cell site to an Omni-cell site can be advantageous to initiate. This is because the user performance can be kept using a more energy efficient network configuration.

In accordance with one embodiment the threshold is defined dependent on a few factors, for example: the type of user, a predominant type of traffic, mobility. This can be expressed as a function (f) of the different factors.

Threshold=f(user type, dominated traffic type, mobility etc).

In accordance with one embodiment, once a site has been identified as a candidate site the following steps are executed:

1. Blocking the Cells

Once the site has been identified as a reconfiguration candidate, the cells in the site are blocked for new users. This can be performed by sending a broadcast message to user equipments in the affected cells. For example, an information element called “Cell Access Restriction” indicating the access restriction of a cell has been defined in the specification 3GPP 25331 series, “Technical Specification Group Radio Access Network; Radio Resource Control (RRC);Protocol specification”, which can be broadcasted over the Broadcast Control Channel (BCCH) to the user equipments in the cell(s). This information element could be used to inform users of the limited access during the cell reconfiguration period. Such a broadcast will decrease the delays since users do not have to do access attempts to discover that a cell is blocked. UEs may not access the blocked cells unless they are at risk of not complying with QoS.

2. Emptying the Cells

For all users currently served in the cell(s) which are candidate for reconfiguration, the below actions can be performed for each user.

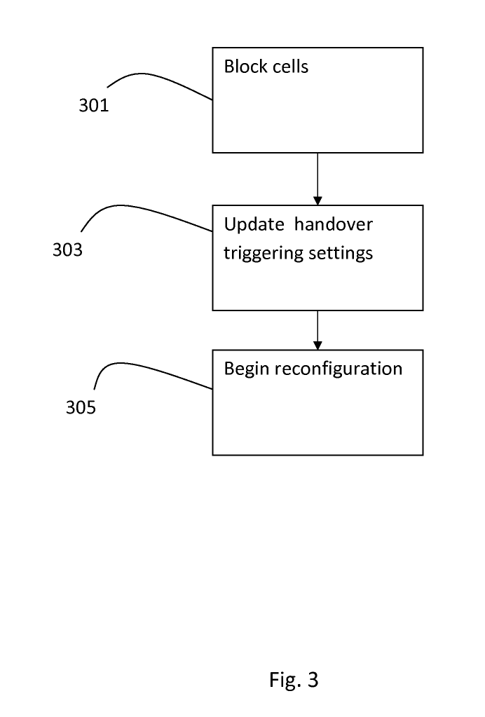

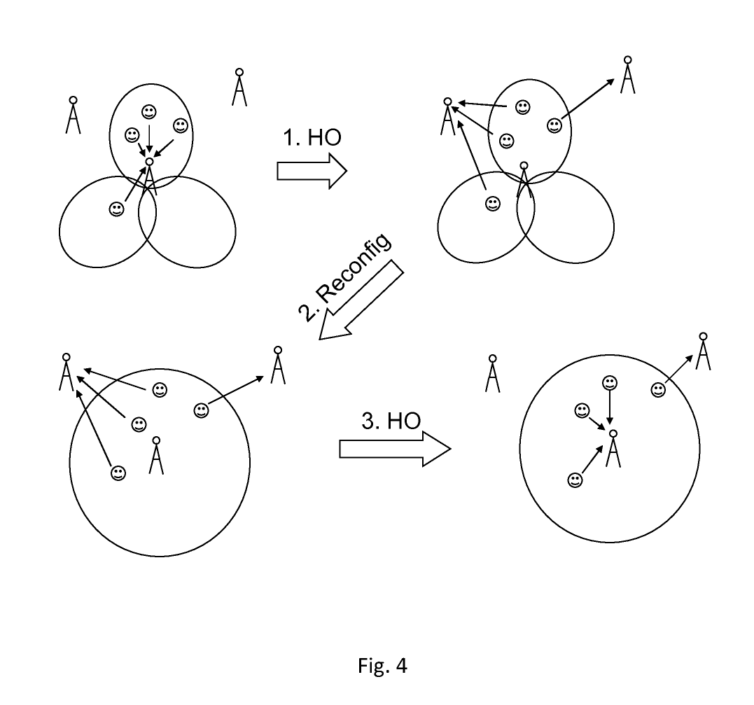

In FIG. 3 a flowchart illustrating some of the above steps performed when reconfigurating a cell from a multi cell configuration to an omni-cell configuration is depicted. First in a step 301, cells of the multi cell configuration is blocked for new users by preventing a user equipment from access any of the cells in the multi cell configuration. Next in a step 303, the handover triggering settings for user equipments in the cells of the multi cell configuration are updated with new settings set to empty the cells at an increased handover rate or speed. Then, in a step 305, the reconfiguration beginning from the multi cell configuration to the omni-cell configuration is begun when all cells in the multicell configuration are empty.

Node B/RNC updates the HO triggering settings with new settings set to empty the cells at an increased handover rate or speed. The updated settings are communicated to the UEs, in order to let users trigger immediate HO. The handover is only triggered if this is possible. In accordance with one embodiment the HO is made to the best (not blocked) cell. In accordance with one embodiment handover is only allowed if the RSCP (or a comparative measure) from the intended target cell is above a threshold value. The threshold is set to guarantee QoS during reconfiguration to an Omni site configuration. In accordance with one embodiment, if there is no other cell which has the RSCP above the threshold no HO and no reconfiguration to an Omni site configuration is performed since the QoS requirements can not be kept during the reconfiguration. If this is the case, a retry may be performed when the next HO event for this user is triggered. Alternatively, new settings for triggering a handover may be tried or as a last option, wait until this user is finished.

In FIG. 4 an illustration of an exemplary HO procedure of users during a reconfiguration from a multi site configuration to an omni site configuration is depicted. Note that in this specific case, one user remains at the neighbor cell, i.e. does no HO to the new Omni-cell.

As shown in FIG. 4, the following steps are performed.

First in a step 1 a candidate site for reconfiguration is identified. Next in a step 2 cells in the candidate site are blocked and information of blocked cells is broadcast to users of the candidate site.

Then in a step 3 the cells in the candidate site are emptied and the following actions can be taken for each user:
Update HO triggering settings with new settings set to empty the cells at an increased handover rate or speed
Perform HO to the best (not blocked) cell if the RSCP from this cell is above a threshold value.

If no other cell has the RSCP above the threshold value, one or more of the following steps can be performed:
i. Retry after a time period
ii. Update HO triggering settings with settings set to empty the cells at a higher increased handover rate or speed settings, i.e. the speed or rate is increased more than with the new settings currently used
iii. Wait until user has finished

Now an example of reconfiguration from an omni-cell site to a multi cell site is given. Again the example given is a multi cell site with 3 cells. Thus, in cases when the network load increases, it may be necessary to reconfigure the Omni-cell site back to the original 3-cell site. This is since the Omni-cell has a more limited capacity and coverage, than the 3-cell site deployment.

As above, a site is identified as a reconfiguration candidate (to multi-cell/3-cell). This can done based on the base criterion:

Base Criterion. Number of users served in the Omni-cell site or the site(cell) throughput reaches a threshold.

When the number of served users or the cell throughput reaches the threshold, a reconfiguration of the Omni-cell site to a multi-cell can be advantageous to initiate.

In accordance with one embodiment the threshold is defined dependent on a few factors, for example: the type of user, a predominant type of traffic, mobility. This can be expressed as a function (f) of the different factors.

Threshold=f(user type, dominated traffic type, mobility etc).

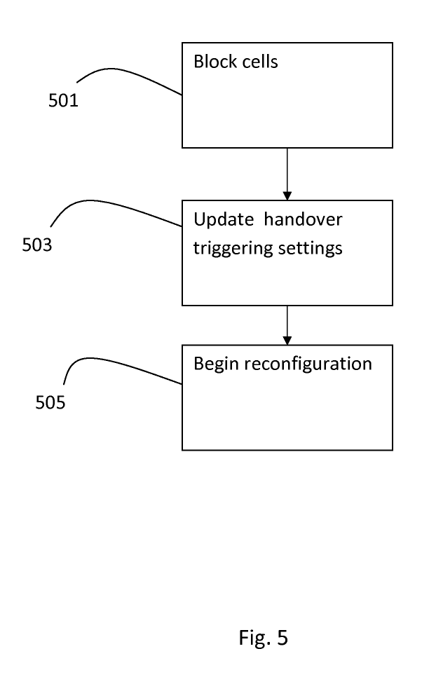

Once a site has been identified as a candidate site to reconfigure from an omni site to a multi cell site, the corresponding steps to block the Omni-cell and empty it are executed as above can be performed. For example, first cells in the candidate site are blocked and information of blocked cells is broad cast to users of the candidate site. This is illustrated in FIG. 5.

FIG. 5 is a flowchart illustrating some of the above steps performed when reconfigurating a cell from an omni-cell configuration to a multi cell configuration. First in a step 501, cells of the omni cell configuration is blocked for new users by preventing a user equipment from access to the omni cell. Next in a step 503, the handover triggering settings for user equipments in the omni cell are updated with settings for triggering a handover. Then, in a step 505, the reconfiguration beginning from the omni-cell configuration to the multi cell configuration is begun when the omni cell is empty.

When the cells in the candidate site are emptied and the following actions can be taken for each user:
Update HO triggering settings with settings for triggering a handover
Perform HO to the best (not blocked) cell if the RSCP from this cell is above a threshold value.

In accordance with one embodiment additional criteria can be used to ensure that user QoS can be kept during the reconfiguration process from an Omni cell configuration to a multi-cell configuration.

In accordance with one embodiment other cells, in particular neighbor cells, are monitored to ensure that there is an alternative cell for users in the Omni-cell. Unless this is the case, there is no possibility to reconfigure the Omni-cell since there are no alternative cells to hand over to. The following criteria can be used:

Criterion 1. The serving radio network controller (SRNC) counts the user equipments in other cells that have initiated HO to the Omni cell, and have no other cell which has RSCP above a given threshold value during a given period. If the number of such kind of users is over a threshold it is time to reconfigure the Omni cell to 3-cell site. Accept the user equipments having initiated handover after the reconfiguration finishes

Criterion 2. The SRNC monitors measurement reports for all user equipments in the Omni cell. If the number of users, who have no other r cells with RSCP over a threshold, is over a predefined threshold during a given period, the reconfiguration to multi cell (3-cell) must start.

In accordance with one embodiment, in cases where there is no alternative cell with sufficient RSCP to hand over to, the user equipment can be denied to perform a handover. Instead, the user equipment is set to stay within the cell which is being reconfigured. This may cause an interruption but it will probably be smaller than if a HO was made to a cell with insufficient RSCP.

Using the methods and devices as described herein will provide a site reconfiguration for energy efficiency that is faster and with control of the user equipment performance during the reconfiguration process. Also it is made possible to maintain QoS for users during reconfiguration, improve the network energy efficiency while maintaining QoS for users and shorten delays when blocking and emptying cell(s).

1. A method in a node of a cellular radio system for reconfiguration from a multi cell configuration to an omni-cell configuration, the method comprising the steps of:
blocking cells of the multi cell configuration for new users by preventing a user equipment from access any of the cells in the multi cell configuration;
updating handover triggering settings for user equipments in the cells of the multi cell configuration with new settings set to empty the cells at an increased handover rate or speed while continuing to prevent the user equipment from accessing any of the cells in the multi cell configuration; and
beginning reconfiguration from the multi cell configuration to the omni-cell configuration when all cells in the multicell configuration are empty.

2. The method according to claim 1, wherein the reconfiguration is initiated when the number of served user equipments or the cell throughput provided is below a threshold.

3. The method according to claim 1, wherein cells are blocked by transmitting a broadcast message informing user equipments that a cell/cell(s) cannot be accessed during a period.

4. The method according to claim 1, wherein in response to no other cell having a received signal code power above a threshold, one or more of the following steps are performed:
retry after a time period;
update the handover triggering settings with settings set to empty the cells at a higher increased handover rate or speed settings; and
wait until the user equipment is finished.

5. The method according to claim 1, wherein the reconfiguration is aborted if a user equipment is determined to not comply with a Quality of Service unless given access to a cell in the multi cell configuration.

6. The method according to claim 1, wherein the handover triggering settings are updated in a radio base station, Node B, or a Radio Network Controller.

7. The method according to claim 1, wherein the reconfiguration is aborted if in response to no other cell for a user equipment having a received signal code power above a threshold value.

8. A method in a node of a cellular radio system for reconfiguration from an omni-cell configuration to a multi cell configuration, the method comprising the steps of:
blocking the omni cell configuration for new users by preventing a user equipment from access to the omni cell;
updating handover triggering settings with new settings set to empty the cell at an increased handover rate or speed for user equipments in the omni cell while continuing to prevent the user equipment from access to the omni cell; and
beginning reconfiguration from the omni-cell configuration to the multi cell configuration to when the omnicell is empty.

9. The method according to claim 8, wherein other cells are monitored to ensure that there is an alternative cell for users in the Omni-cell.

10. The method according to claim 8, wherein the reconfiguration is initiated when the number of served user equipments or the cell throughput provided is above a threshold.

11. The method according to claim 8, wherein the handover triggering settings are updated in a radio base station, Node B, or a Radio Network Controller.

12. A node in a cellular radio system adapted for reconfiguration from a multi cell configuration to an omni-cell configuration, the node comprising:
controller circuitry for blocking cells of the multi cell configuration for new users by preventing a user equipment from access any of the cells in the multi cell configuration;
controller circuitry for updating handover triggering settings for user equipments in the cells of the multi cell configuration with new settings set to empty the cells at an increased handover rate or speed while continuing to prevent the user equipment from accessing any of the cells in the multi cell configuration; and
controller circuitry for beginning reconfiguration from the multi cell configuration to the omni-cell configuration when all cells in the multicell configuration are empty.

13. The node according to claim 12, wherein the controller circuitry is configured to initiate the reconfiguration when the number of served user equipments or the cell throughput provided is below a threshold.

14. The node according to claim 12, wherein the controller circuitry is configured to block cells by transmitting a broadcast message informing user equipments that a cell/cell(s) cannot be accessed during a period.

15. The node according to claim 12, wherein the controller circuitry is configured to perform one or more of the following steps if no other cell has a received signal code power above a threshold,
retry after a time period;
update the handover triggering settings with settings set to empty the cells at a higher increased handover rate or speed settings; and
wait until the user equipment is finished.

16. The node according to claim 12, wherein the controller circuitry is configured to abort the reconfiguration if a user equipment is determined to not comply with a Quality of Service unless given access to a cell in the multi cell configuration.

17. The node according to claim 12, wherein the node is a radio base station, Node B, or a Radio Network Controller.

18. The node according to claim 12, wherein the controller circuitry is configured to abort the reconfiguration in response to no other cell for a user having a received signal code power above a threshold value.

19. A node in a cellular radio system adapted for reconfiguration from an omni-cell configuration to a multi cell configuration, the node comprising:
controller circuitry for blocking the omni cell configuration for new users by preventing a user equipment from access to the omni cell;
controller circuitry for updating handover triggering settings with new settings set to empty the cell at an increased handover rate or speed for user equipments in the omni cell while continuing to prevent the user equipment from accessing to the omni cell ; and
controller circuitry for beginning reconfiguration from the omni-cell configuration to the multi cell configuration to when the omnicell is empty.

20. The node according to claim 19, wherein the controller circuitry is configured to monitor other cells to ensure that there is an alternative cell for users in the Omni-cell.

21. The node according to claim 19, wherein the controller circuitry is configured to initiate the reconfiguration when the number of served user equipments or the cell throughput provided is above a threshold.

22. The node according to claim 19, wherein the node is a radio base station Node B, or a Radio Network Controller.
